(19) United States
(12) Patent Application Publication
(10) Pub. No.: US 2026/0007501 A1
(43) Pub. Date: Jan. 8, 2026

(54) Food Trap Removal Tool

(71) Applicant: David Gregory Hadaway, Granada Hills, CA (US)

(72) Inventor: David Gregory Hadaway, Granada Hills, CA (US)

(21) Appl. No.: 18/652,782

(22) Filed: Jul. 7, 2024

(51) Int. Cl. A61C 15/02

(52) U.S. Cl. CPC A61C 15/02

(57) ABSTRACT

A food trap removal tool that is made of a high quality plastic with a wedge design. The tool is designed to push food that is stuck between teeth with larger than normal space that floss and toothpicks cannot get to.

SEQUENCE LISTING (See MPEP §2424 and 37 CFR 1.821-1.825. A “Sequence Listing” is required on paper if the application discloses a nucleotide or amino acid sequence as defined in 37 CFR 1.821(a) and if the required “Sequence Listing” is not submitted as an electronic document either on compact disc or as a text file via the Office electronic filing system (EFS-Web.) n/a

CROSS-REFERENCE TO RELATED APPLICATIONS: n/a

STATEMENT REGARDING FEDERALLY SPONSORED RESEARCH OR DEVELOPMENT: n/a

THE NAMES OF THE PARTIES TO A JOINT RESEARCH AGREEMENT: David Hadaway

INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB): n/a

STATEMENT REGARDING PRIOR DISCLOSURES BY THE INVENTOR OR A JOINT INVENTOR: n/a

### BACKGROUND OF THE INVENTION:

(1) Field of the Invention:

This invention is a tool that allows the user to remove food that is stuck between two teeth that have a larger than normal opening that dental floss and/or a toothpick cannot remove.

(2) Description of Related Art including information disclosed under 37 CFR 1.97 and 1.98: This invention is intended for the use by individuals that have larger than normal space between two teeth. This tool is intended to replace the use of plastic straws and business cards from being used to push out the food that trapped between the teeth at the gum line. This tool comes in different thicknesses ranging from 0.127 mm to 0.508 mm with the most common size of 0.318 mm.

### BRIEF SUMMARY OF THE INVENTION

The tool in accordance with this invention is a specific thickness of high quality plastic between the thickness of 0.127 mm and 0.508 mm. The most common size thickness is 0.318 mm. The plastic is cut to 63.5 mm on the bottom by 50.8 mm on the top by 9.525 mm tall with a return angle of 3.175 mm from the 63.5 mm to the 50.8 mm for a wedge shape at one end. All edges are rounded.

### BRIEF DESCRIPTION OF THE SEVERAL VIEWS OF THE DRAWING(S)

FIG. 1 shows: is a side view of the invention

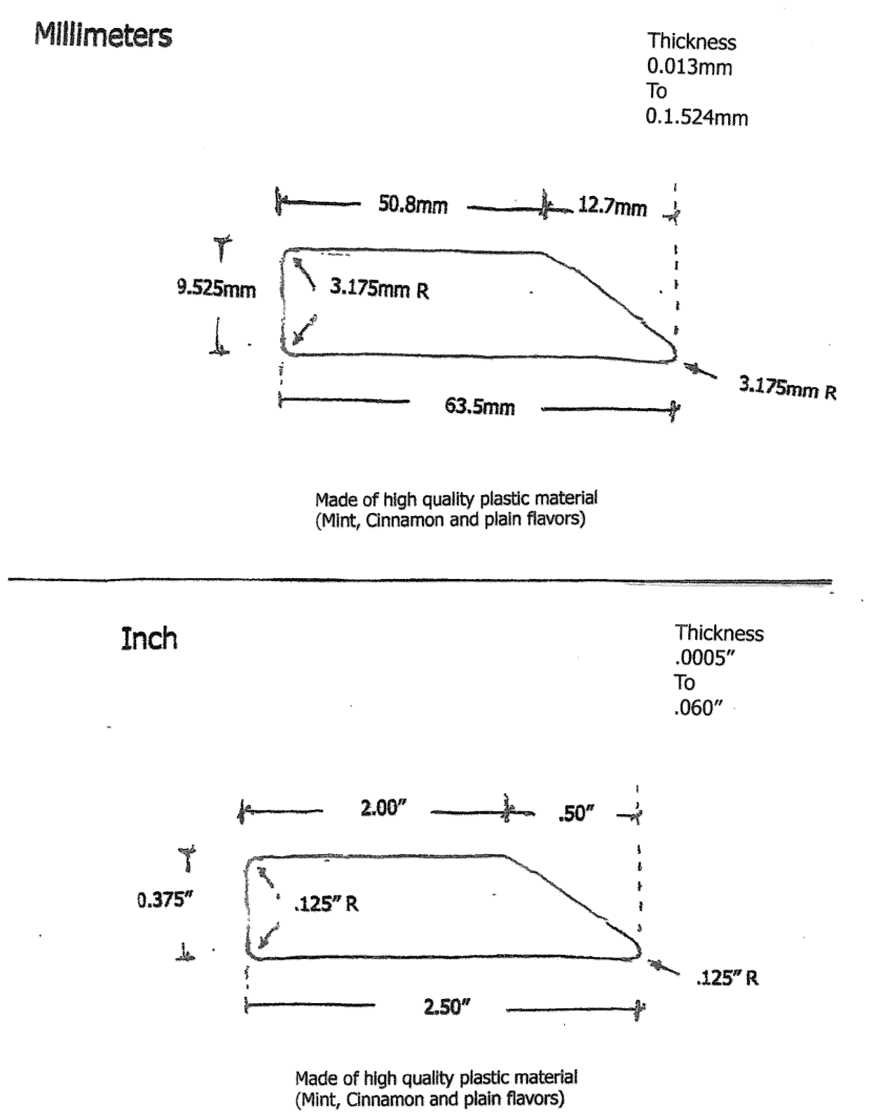

### DETAILED DESCRIPTION OF THE INVENTION

The tool is made out of one specific thickness of high quality plastic between the thickness of 0.127 mm and 0.508 mm. The tool is cut to 63.5 mm on the bottom by 50.8 mm on the top by 9.525 mm tall with a return angle of 3.175 mm from the 63.5 mm to the 50.8 mm for a wedge shape at one end. All edges are rounded.

1. The tool is different from other tooth picks and floss because of its unique thickness and wedge design. The wedge can be used as a pick for teeth that are spaced tightly together as well as a lifting tool to remove food from the gum line when pushed through the larger spaced teeth. The thickness of the tool comes in different sizes depending on the different size of space between the teeth. Whereas the most common size is 0.318 mm the tool also comes in 0.127 mm, 0.191 mm, 0.254 mm, 0.381 mm, and 0.508 mm.
